(19) United States
(12) Patent Application Publication
(10) Pub. No.: US 2006/0031436 A1
(43) Pub. Date: Feb. 9, 2006

(54) Systems and methods for multi-level gateway provisioning based on a device's location

(76) Inventors: Jayson Sakata, Stevenson Ranch, CA (US); Christopher Bradley, San Marcos, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/856,221

(22) Filed: May 28, 2004

(51) Int. Cl. G06F 15/177

(52) U.S. Cl. 709/221

(57) ABSTRACT

A system for providing diverse broadband service levels to multiple access points within an established network is provided. Specifically, the system comprises a guest device connected to an access point within the established network and configured to initiate a request for broadband service access. A gateway, in communication with the guest device intercepts the request from the guest device and identifies the access point to which the guest device is connected. Upon interception, the gateway replies to the intercepted request with a predetermined IP address. A connection between the guest device and the established network is formed and a portal webpage, associated with the identified location, is transmitted to the guest device. The portal page allows the guest to select service options available to that location within the established network.

### BACKGROUND

1. Field of the Inventions

The present invention relates to multi-level gateway provisioning. More specifically, the present invention relates to a gateway, having a centralized management system capable of providing multi-level Internet access, based on the network location of the connected terminal.

2. Background Information

The Internet has profoundly changed the exchange of data and communications. People now expect to be able to access the Internet from virtually any location. To stay competitive and meet this increasing expectation, enterprises such hotels, public venues and multi-unit dwellings, are offering high speed Internet access to their guests by allowing the guest to connect their device to the enterprise's established network. In order for a guest device to function properly in the established network, the guest device must be configured with the proper protocols enabling the device to transmit and receive data over the established network.

Networks are configured to meet a unique set of requirements. Computers which are not initially configured to communicate with the established network typically have different configurations. For example, business travelers expect to connect their portable computer to a hotel's network in order to complete work while away from the office. A guest device may be any remote computer, handheld devices, PDA's, or other portable wireless or wire-line devices. However, the guest device mostly likely is not properly configured to communicate with a hotel's network. Therefore, the business traveler must reconfigure the settings and protocols on the device in order to communicate with the hotel's network. Reconfiguring one's device is both time consuming and prone to error, thus amounting to nothing short of a headache for both the business traveler and the hotel's IT department.

Gateways provide efficient network access and eliminate the need to reconfigure computers in accordance with native network specifications. A gateway is used to transparently connect two otherwise incompatible networks. Moreover, a gateway also acts as an interface between the remote computer and the hotel's established network when the remote computer attempts to connect to the Internet or any other network. Gateways are advantageously configured to adapt to the remote computer. Thus allowing the remote computer to communicate with the established networks in a manner that is both transparent to the remote computer and the network itself. Once the gateway is adapted, the remote computer may communicate using the hotel's established network. Gateways are now employed, for service and revenue-generating purposes, in numerous venues including but not limited to: airports, convention centers, hotels, and multi-unit dwellings. Such venues demand network access to be met in a seamless and user friendly manner.

Although the pains associated with reconfiguring a remote computer for communication with an established network has been greatly diminished, enterprises are not able to offer diversity of service via their established network. In other words, a guest may access a enterprise's network without having to reconfigure their device. However that guest is not offered any quality of service choices regarding their network access. Additionally, enterprises offering network access are unable to offer differing network service options based on the location from which the guest connects to their network. For example, a hotel may be equipped with VLAN network connections in each guestroom while using wireless hotspots for network connections in its conference rooms and lobby. Currently, there is no technology that allows certain network services and pricing schemes to be offered to the guest utilizing the wireless hotspot while other services and pricing schemes are offered to the guests using the VLAN connection.

### SUMMARY OF THE INVENTION

In order to combat the above problems, there is provided a system and method for providing multi-level network access based on the location from which the guest device accesses the established network.

In the first embodiment, a system and method for offering multi-level services based on the location of a guest device within an established network is provided. The established network may be a hotel network, airport network, convention center network, cable service provider, multi-unit dwelling or any other network capable of being accessed by a guest device. Similarly, a guest device is any terminal not originally configured to communicate with the established network. This includes, but is not limited to computers and any and all portable devices. Upon connecting with the established network, the guest device transmits a DNS request that is intercepted by a gateway within the established network. The location of the guest device within the established network is determined based on the intercepted access request. A web-based portal page representing the service options available for the identified location is transmitted to the guest device in response to their original DNS request. The guest device is ultimately provided Internet access in accordance with services selected from the portal page. As such, different broadband service levels are associated with each location within a single established network. Furthermore, the services selected by the guest device form a service protocol that is stored and used to guide broadband service to the device during subsequent connections to the established network.

In another embodiment, a system for providing diverse broadband service levels to multiple access points within an established network is provided. Specifically, the system comprises a guest device connected to an access point within the established network and configured to initiate a request for broadband service access. A gateway, in communication with the guest device intercepts the request from the guest device and identifies the access point to which the guest device is connected. Upon interception, the gateway replies to the intercepted request with a predetermined IP address. A connection between the guest device and the established network is formed and a portal webpage, associated with the identified location, is transmitted to the guest device. The portal page allows the guest to select service options available to that location within the established network.

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is diagram of a hotel configured to provide multilevel access control, billing and auto-provisioning using the systems and methods of the present invention;

FIG. 2 is a diagram illustrating how multiple access points connect to the gateway implemented within the established network;

FIG. 3 is a flow chart depicting the process of providing multi-level access based on the location of a guest device utilized by the gateway of the present invention;

FIG. 4 is a screenshot of a portal page for a particular access point or location within an established network;

FIG. 5 is a diagram illustrating the multi-level gateway provisioning of the present invention implemented in an enterprise or retail environment; and

FIG. 6 is a diagram illustrating the multi-level gateway provisioning of the present invention for centralized network management purposes.

### DETAILED DESCRIPTION OF THE PREFERRED EMBODIMENTS

In the descriptions of example embodiments that follow, implementation differences, or unique concerns, relating to different types of systems will be pointed out to the extent possible. But it should be understood that the systems and methods described herein are applicable to any type of network system.

Staying competitive in today's Internet savvy environments requires the ability to offer multi-level services controlled from a centralized location. The present invention facilitates this objective by providing an apparatus, system and method that enables an established network to offer multi-level broadband services based on the location of a guest device within the established network. The established network may be a hotel network, airport network, convention center network, enterprise/retail network, cable service provider network or any other network capable of being accessed by remote or guest users. Similarly, a guest device is any terminal not originally configured to communicate with the established network, including but not limited to: computers, televisions, and all portable devices.

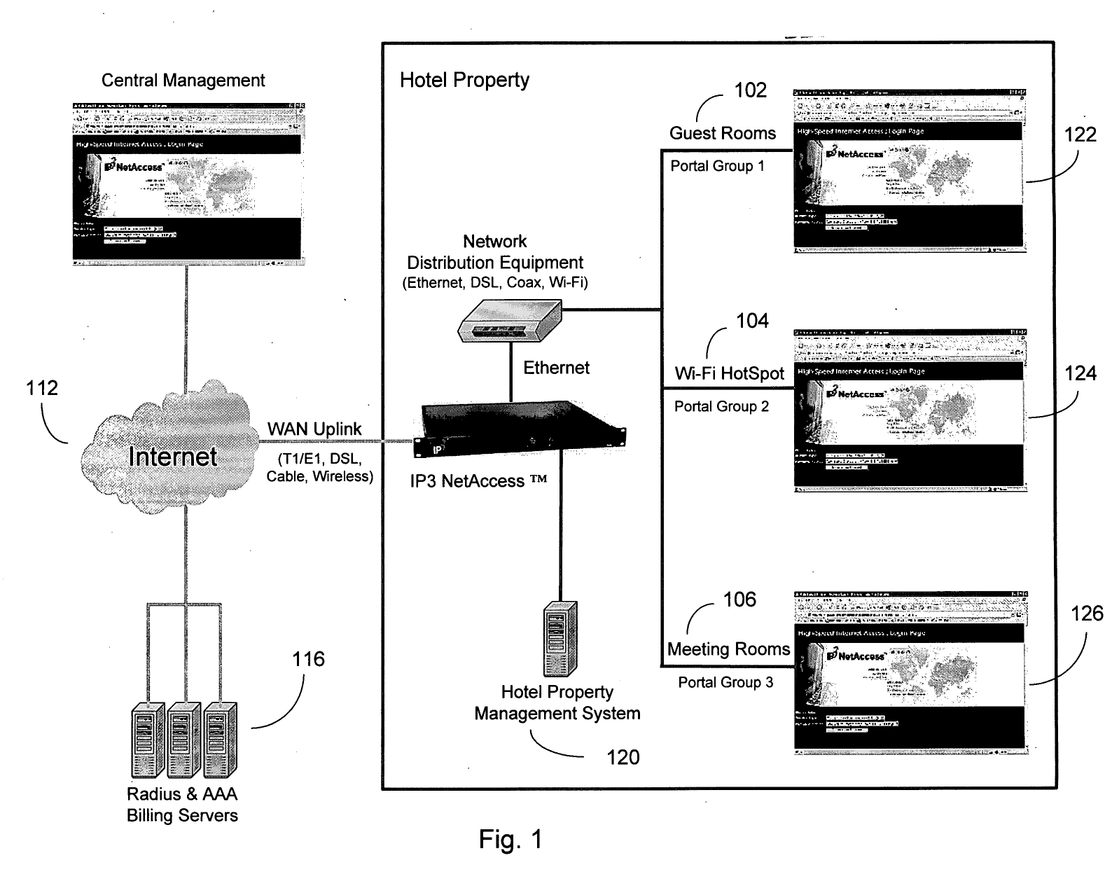

FIG. 1 is a diagram of a hotel configured to provide multilevel access control, billing, and auto-provisioning using the systems and methods of the present invention. It should be noted that these systems and methods may be incorporated into any established network as will be described in detail below. Thus, the description of a hotel network is only for exemplary purposes and therefore non-limiting. As illustrated in FIG. 1, the hotel network 100 has many different locations on the hotel property that offer Internet access to the guests including but not limited to the guestrooms 102, WI-FI hotspots in areas such as the lobby 104 and conference or meeting rooms 106. These locations, referred to herein as access points, use different communication mediums to connect to the hotel network 100. As illustrated in FIG. 1, the guestrooms 102 may connect to the hotel network 100 using a VLAN 802.1q transport medium connection protocol, while the lobby 104 provides a wireless hotspot connection to the hotel network 100 using a WI-FI transport medium connection protocol. Additionally, the conference rooms 106 may offer both a wireless and a wire line connection to the hotel network 100 using transport medium connection protocols including but not limited to SNMP 1493 and IEEE 802.1q. In short, a guest device 108 may attach to the hotel network 100 at any access point, each of which is serviced by at least one of a variety of transport medium connection protocols.

A gateway 110 is incorporated within the hotel's established network 100 in order to provide a variety of broadband and Internet services to each individual access points in accordance with the connection protocol implemented by each access point. As depicted in FIG. 1, the gateway 110 acts as an interface in connecting guest devices 108, coupled to the hotel network 100, with the Internet 112. The gateway 110 may be managed using a central management platform 114 that enables both remote and local administration of the hotel network 100 and further provides for a centralized management platform for distributing Internet/broadband services. More specifically, the gateway 110 communicates with the central management platform 114 via XML over a secured socket layer (SSL) encrypted session.

As further illustrated in FIG. 1, the gateway may also communicate with authentication, authorization, and accounting (AAA) systems and servers. An AAA server handles guest requests for access to computer resources belonging to the hotel's established network 100. Specifically, the server provides the established network 100 with authentication, authorization and accounting services for each guest that requests Internet or network access. As such, the hotel network uses an AAA server, located within or outside of the hotel network, for accounting purposes. A current standard by which devices, such as the gateway, communicate with an AAA server includes but is not limited to the Remote Authentication Dial-In User Service (RADIUS). The interaction between the AAA server and the gateway is well known in the art and is therefore not discussed in detail herein. It is important to note, however, that the AAA functions may be implemented in a variety of ways. For example, the central management platform 114 may be tied to the back end of a RADIUS system for user authentication and accounting purposes. The central management platform 114 may also communicate with credit card clearing houses for AAA services. Alternatively, the gateway 110 itself may have integrated within the necessary software and hardware to implement the AAA functions without the use of a centralized management platform.

As further illustrated in FIG. 1, the gateway 100 is connected to network distribution equipment 118. The network distribution equipment is used to manage the multiple transmission mediums, including but not limited to the Ethernet, DSL, Coax or Wi-Fi medium, associated with the multiple access points (102, 104, 106) incorporated into the hotel network 100. Furthermore, the gateway 110 may also be coupled to a hotel property management system 120 in order to provide a seamless and integrated network.

The gateway 110 further includes an internal web server that acts as an on-site login portal for managing the billing and authentication process. More specifically, each access point (102, 104, and 106) within the hotel network 100 is associated with predefined service options presented to the guest via a location based portal page (122, 124, or 126). Thus, upon connecting to the hotel network 100, the location of the guest device 108 is determined and matched with the appropriate portal page (122, 124, or 126) based on the determined location. As such, the guest device 108 is presented with a portal page (122, 124, or 126) that offers service options for the particular access point (102, 104, or 106) to which the guest device 108 is connected. Service options offered in conjunction with an associated access point via the portal page include, but are not limited to: bandwidth speed, unique content, and various pricing plans. For example, a guest device connecting via a wireless hotspot may be provided with portal page service options that differ from the portal page service options provided to a guest connecting to the network via the 802.1q VLAN connection in their guestroom. Therefore, different broadband service options may be provided to different access points within a single established network.

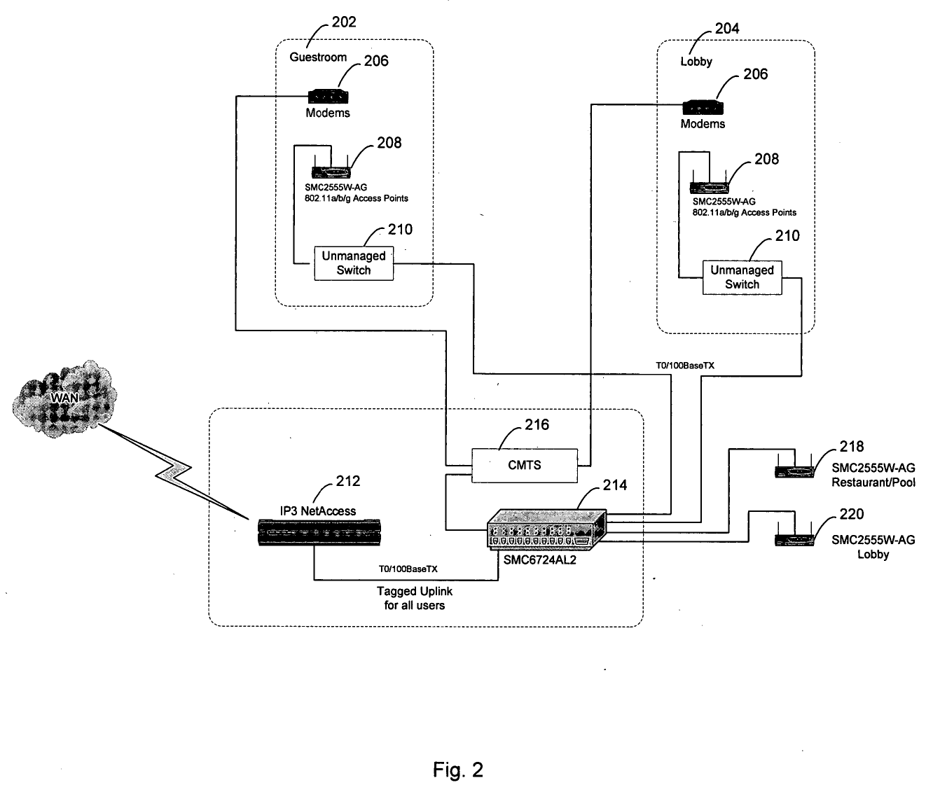

FIG. 2 illustrates how the gateway of the present invention is implemented into an established network. As shown, the guestroom access point/location 202 and the wireless lobby access point/location 204 include a modem 206, an access point uplink 208, and an unmanaged switch 210 coupled together using 100Base SX/LX or fiber optic cabling. The gateway 212 is configured with at least two portals, one for wireless users and one for wired users. The gateway is also connected to a managed switch 214 via a 10/100base tagged uplink. A cable modem termination system (CMTS) 216 may also be connected to the managed switch 214. As shown, access points may also be provided in additional hotel areas including the pool or the lobby.

Against this background, all guest's devices connected to the hotel network via a wired location (those in guestrooms 202) are linked to the gateway 212 through the cable modem 206. The CMTS 216 uplinks data packets received via modem 206 to the managed switch 214. The data packets are then individually configured for the predefined transport medium connection protocol associated with the guestroom 202 access point. The transport medium connection protocols associated with the wired guestroom access point may include but are not limited to 802.1q VLAN's, SNMP, or DOCSIS for cable communications. As explained in more detail below, the gateway ultimately redirects the guest device to a portal page associated with the guestroom 202 location and more specifically associated with the transport medium with which the guest is using to access the hotel network. The guest may then select broadband service options available with that particular access point.

Similarly, all wireless access points are plugged into a given port of a managed switch 214. The given port is an untagged member of a specific VLAN. On the uplink port of the switch, the VLAN is assigned a tagged format. As such, any traffic from the wireless access point 204 is tagged upstream and thus identifiable. Once the access point is identified, the guest device is redirected to the portal page associated with the wireless access point (or lobby 204). The guest may then select broadband service options available for the wireless access point.

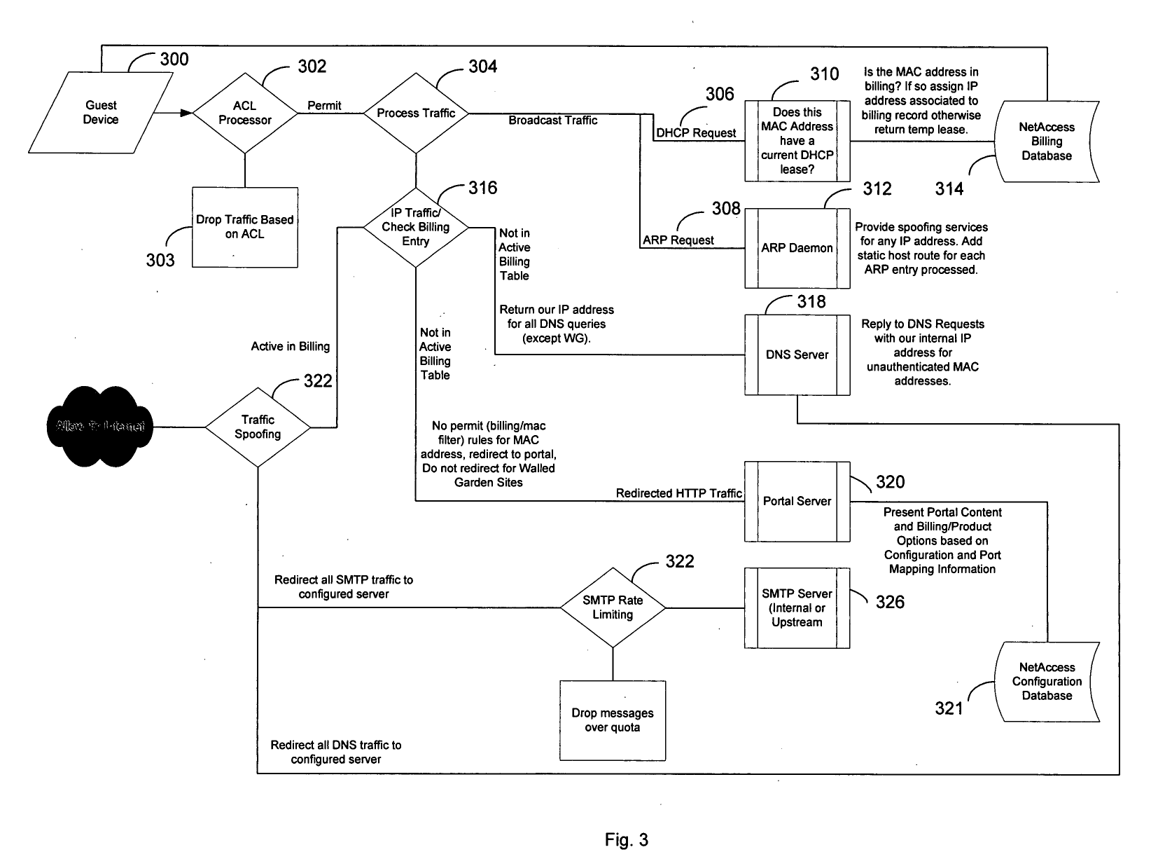

Turning now to FIG. 3, a flow chart is provided that depicts the process of providing multi-level broadband services based on the location of a guest device. Specifically, a guest 300 connects their device to one of the multiple access points within the hotel. For exemplary purposes only, the description focuses on a wired connection from a hotel guestroom. However, it is important to note that the process is the same regardless of the location (wire-line or wireless) from which the user connects to the network. As shown in step 302 all traffic between the network and the guest device passes through an access control list (ACL) filter. The ACL filter is global to the network interface and checks every packet received against predefined filter rules in order to filter out malicious traffic types such as viruses. If a received packet is matched with an ACL filter rule, the packet is dropped from transmission as shown in step 303.

Once the device is physically plugged into the guestroom modem, step 304 determines whether the initial traffic transmitted from the guest device for network connection is IP traffic or the broadcast traffic. If the traffic is broadcast traffic, the guest device is configured to communicate on the hotel network by transmitting either a dynamic host configuration protocol (DHCP) request 306 or an address resolution protocol (ARP) request 308. DHCP permits a server to allocate IP addresses automatically or dynamically to the guest device thus allowing the guest device to send and receive datagrams over the network. The gateway therefore includes a customizable internal DHCP server that allows the established network to share IP addresses for simple Internet access while static IP mapping and IP port binding capabilities provide tight control of routable IP addresses and the ability to map IP addresses to specific locations for management of internal devices.

Upon receiving the DHCP request, the MAC address of the guest device is identified and a search is performed to determine whether the MAC address of the guest device already has a current DHCP lease as shown in step 310. If the MAC address of the guest device is found in the active billing database 314, the guest device is allowed immediate access to the Internet. If the MAC address is not found in the active billing database 314, an IP address is dynamically assigned to the device enabling the device to transmit and receive over the hotel network.

Returning to step 304, if the traffic request transmitted by the guest device is an ARP request 308, the request is processed by an ARP daemon 314. The ARP daemon 314 maps IP addresses to the appropriate MAC address, provides spoofing services for all IP addresses and adds a static host route to each ARP entry processed. Specifically, upon receiving the ARP request from the guest device, the ARP daemon spoofs the ARP request with the default gateway IP address of the client machine by replying to the ARP request with the gateway's MAC address. By replying to the original ARP request with the gateway's MAC address, the guest device is now able to communicate with the gateway within the established network. The ARP daemon is further capable of adding routes at the system level in order to maintain location information for a given guest device. This added functionality allows the gateway to determine which transport medium connection protocol or interface a guest device is connected to when the ARP entry expires. This allows the gateway to issue an ARP request on only one interface for the guest device as opposed to issuing an ARP request for every network interface.

Once the guest device is connected to the network such that the device can properly transmit and receive IP traffic, a guest may attempt to reach a specific network or website by opening the web browser and transmitting a DNS request. The DNS request is received in step 316 where a determination is made as to whether the guest device is a new subscriber or a returning subscriber. A subscriber is a guest device who has an active billing entry. A non-subscriber is a guest device that is does not have an active billing entry. If the MAC address for the guest device transmitting the DNS request is found in the active billing table, the guest device is deemed an authenticated subscriber and their traffic is allowed out of the established network. On the other hand, if the MAC address of the device is not located in the active billing table, the guest device is deemed an unauthenticated subscriber and their DNS request is intercepted by the gateway's DNS server 318. The gateway's DNS server 318 then replies to the unauthenticated subscriber's DNS request with a predetermined IP address. Therefore, the guest's DNS request is replied to using the predefined IP address that directs the guest device to a portal server 320 on the hotel network thus allowing the guest user to connect directly to the established network.

Once at the portal server 320, the location from which the original DNS request was transmitted must be identified. Numerous methods may be used to identify the access point on the hotel network from which the request was transmitted. The portal server 320 either generates SNMP queries to the network equipment or decodes the VLAN header depending on the system configuration. In this example, the original DNS request was transmitted from a guest device connected to the hotel network via an 802.1q VLAN transport medium. Therefore, the packet's VLAN header is read to identify the network location. For transport mediums using the SNMP 1493 standard, the network distribution equipment is queried with the device's MAC address to determine the connecting ports. These examples simply provide an illustration of how the location of a guest device may be determined and should not be construed as limiting.

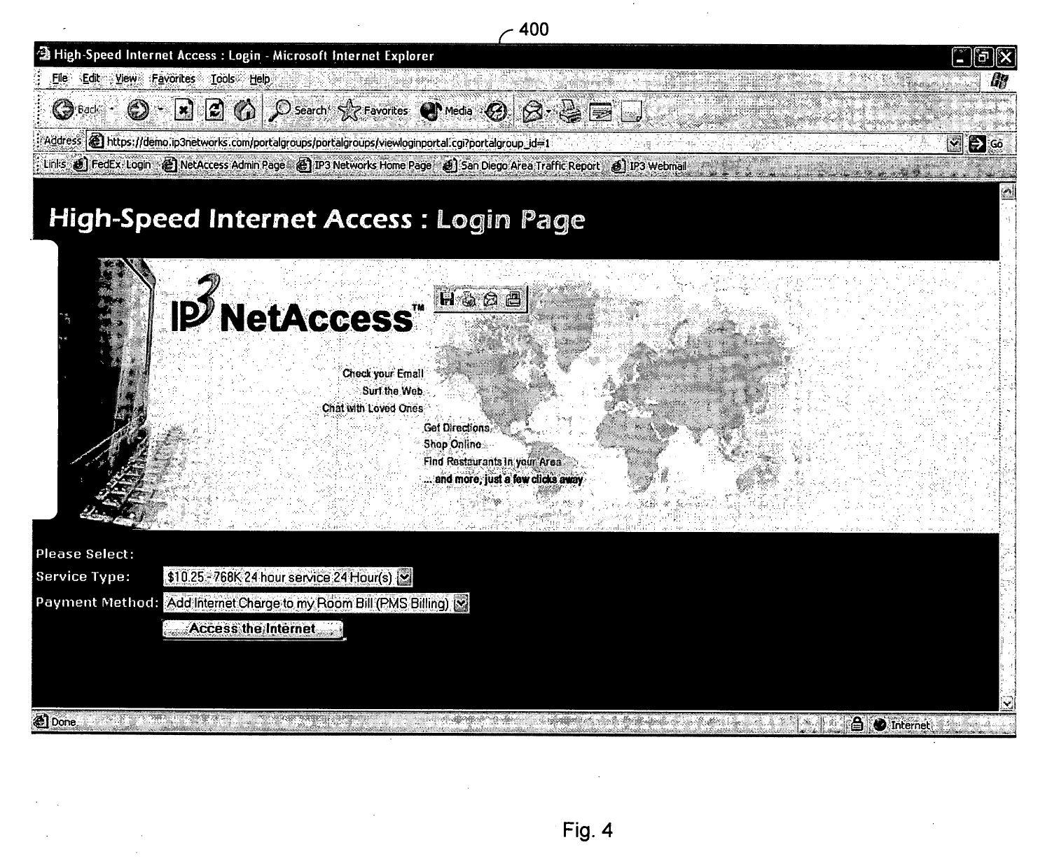

Upon identifying the location of the guest device on the network, the portal server 320 is configured to associate the identified location with its respective portal page. As mentioned above, a unique portal page is associated with each access point or location on the hotel network. FIG. 4 is a screenshot of a login portal page associated with a hotel access point and presented to a guest for service selection. The portal page 400 includes content, billing 402 and bandwidth 404 options specifically available for the particular transport medium utilized by the access point or location. Once the portal server 320 identifies the guest device's location as using a VLAN 802.1q connection (associated with the guestrooms as described above), the portal server 320 transmits a portal page associated with the VLAN transport medium to the guest device.

The portal page presents a web based login interface allowing the guest to select from the various service options associated with the access point. The guest may become a subscriber by creating an account and selecting their preferred service options such as choosing from multiple billing options such as charge to room or charge to card. Additionally, the guest may select different connection bandwidth speed associated with different pricing schemes. Once the guest has selected their service options and a subscriber account is created, the service options are link to the subscriber's account and act as a protocol as to how the guest device is serviced the next time the guest device connects to the network.

In one embodiment, the portal pages are stored as static HTML pages in the configuration database 321. Dynamic XML may be used to populate options presented on the portal page at the time it is presented to the user. This allows the service options presented for each location to be centrally controlled and automatically updated.

Returning now to step 316, if the guest device is authenticated as a subscriber in the active billing database, the device is allowed immediate access to the Internet without having to be redirected to the portal pages provided by the established network. A subscriber's account may be active for the duration specified by the user upon creating the account. Once the account expires, the subscriber is redirected back to a portal page associated with the subscriber's location. Upon expiration, the guest device is no longer active during the DHCP and DNS transactions. Therefore, the device's MAC address is not included in the active billing database 314. Thus, the process described above is repeated in order to create a new and active account for the device. As described above, if the MAC address of a device is not found in the active billing database in step 314, the traffic transmitted by that device is not let out onto the Internet. This allows the gateway to only look at the MAC address in order to allow or deny access to the Internet.

It is important to note that once a guest service device is authenticated, by locating its MAC address in the active billing database 314, the device is allowed access to the Internet regardless of their physical location on the network. Because only the MAC address for a device is tracked, any time the device moves within the established network, the device will transmit another ARP request and the MAC address will be identified in the database. Therefore, device is granted access to the Internet and the new location information associated with the device is updated. If the guest next connects to the hotel network via the wireless hotspot in the hotel lobby, the location change does not override the service options selected at the time of subscribing (i.e. here the service options were selected while connected to the network from a guestroom utilizing an 802.1q medium). Rather, the new location information updated and the guest is provided with the same services they selected upon their initial subscription. Once the guest device is authenticated as a subscriber in step 316, the guest device is granted Internet access in accordance with their account's service protocol.

It is important to note that guest devices that transition from wired to wireless locations (or vice versa) change network cards in their devices from Ethernet to wireless. Therefore, their MAC addresses also change. In order to allow a subscriber access to any location within the network, a system must be implemented to associate the MAC address stored in the active billing database with the new MAC address utilized by the device in order to allow the subscriber continued service. To allow subscribers to roam throughout the established network, a cookie is stored in the subscriber's browser to allow for a second means of identification in addition to the MAC address. As such, the subscriber will not see an interruption in their selected service even when roaming.

As further illustrated in FIG. 3, not all traffic is sent directly out of the hotel network and to the Internet as shown in step 322. Specifically, all SMTP traffic is redirected to a configured SMTP server 326. The gateway uses an integrated SMTP mail server 326 or a configured SMTP relay to an ISP's SMTP mail server in order to ensure that guests are able to send and receive email without reconfiguring their email client software. Because the SMTP server 326 is integrated in the gateway, and thus controllable via the web-based interface, the hotel's network administrators may set spam filters to prevent unwanted email traffic from flooding the system as shown in steps 324 and 328.

In accordance with the above description, service providers including, but not limited to: hotels, convention centers, airports, multi-unit dwellings and cable providers may utilize the gateway and systems of the present invention as intelligent points of presence in their network deployments to manage access to the Internet and to offer a wide variety of next generation broadband-based services. The multiple login portal pages for location based access offering unique contents, bandwidth speeds and pricing plans allows property owners, service providers and other entities to provide a quality of service in high speed Internet access never before realized. The descriptions set forth below are examples of the industries wherein multi-level access policies through location based login portals may be realized. As such, multiple services, access privileges and billing options may be provided based on a myriad of predefined qualifications such as location or grouping.

Industrial Applications:

1. Retail/Enterprise Virtual Business Networks

Hotel, airport, and convention centers may optimally provide visitor-based network service to a wide range of customers segmented according to their location or service type. However, the systems and methods of the present invention are not limited to providing multi-level access based on location. Rather, the systems and methods described above may be utilized with any predefined qualification or grouping. For example, a retail store may offer multi-level broadband access based on predefined groups. In other words, vendors and guestsmay access the retail establishment's network in conjunction with a predefined access/service policy. Similarly, retail employees may also be provided access to the established network under a second access policy.

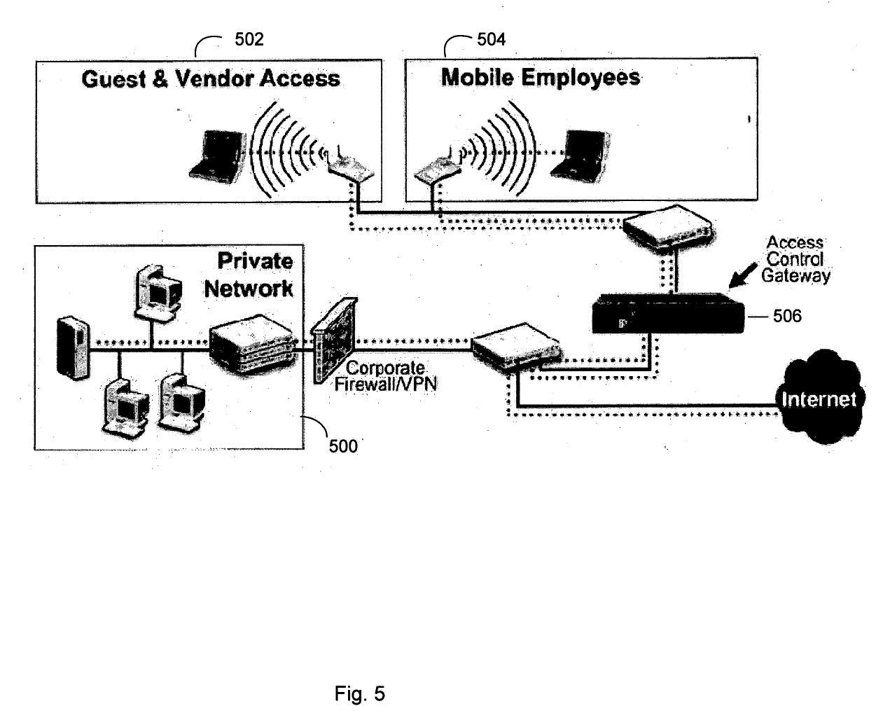

FIG. 5 is a diagram illustrating the gateway of the present invention implemented within the retail virtual business network (VBN) of a retail enterprise. Specifically, different Internet access policies are offered to different groups utilizing the retail enterprise's established network 500. As illustrated, the two access policies are provided in this non-limiting example. The first access policy 502 is used to provide broadband services to guests and vendors of the retail store. An access code login allows the gateway 506 to determine what service/access policy is provided for devices identified as belonging to the guest/vendor policy 502. A second service/access policy 504 provides broadband services to mobile employees within the retail store. Similarly, a secure ID login allows the system of the present invention to identify and provide mobile employee with the predefined set of services associated with the second access policy 504. For example, upon authenticating a device as a mobile employee (thus policy two 504) the mobile employee is provided access to files and local directories. Similarly, identifying a device as a policy one 502 device, the device may only be provided with limited services such as sending and receiving mail over the established network 500. As such, rather than basing the multi-level gateway 506 provisioning on location, the systems and methods of the present invention may be utilized based on user grouping or other predefined qualifications.

2. Convergence

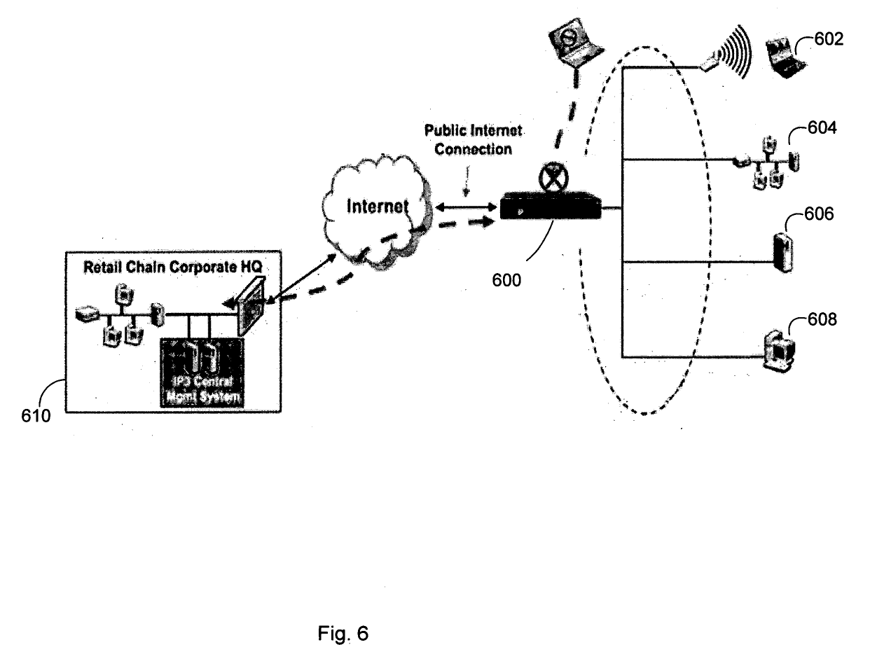

In another embodiment, a system for converging network systems may be provided as illustrated in FIG. 6. Specifically, the gateway 600 of the present invention acts as a interface between multiple access points 602, 604, 606 and 608 and their associated servers on the corporate LAN 610. For example, a retail organization may have all cash register terminals 606 interfacing with a server on the corporate LAN 610, while all modem based machines 604 interface with separate switch on the LAN 610, while the computers 608 interface with yet another server on the LAN 610. The gateway 600 of the present invention simplifies the conventional network by acting as a single interface for receiving incoming traffic. Upon receiving traffic, the gateway identifies the source of the traffic, associates the source with a predefined service protocol and then routes the traffic to the appropriate back end server based on the service protocol.

In yet another embodiment, the gateway provides a more efficient method for cable service providers to roll out cable services. Specifically, cable service providers may sell routers having a thin gateway client embedded within. When the user first connects the router to a cable system, the user may be presented with a portal page allowing the user to select the exact cable service they desire. Providing cable service is this manner eliminates the overhead costs associated with truck roll outs for installation. Furthermore, the self-provisioning of new users is efficient and cost effective.

What is claimed is:

1. A method for offering multi-level Internet access based on a guest device's location, comprising:
intercepting an access request from the guest device;
determining the location of the guest device using the intercepted access request;
associating a service protocol, having predefined network services, with the guest device based on the device's location;
providing the guest device with Internet access in accordance with the protocol.

2. The method of claim 1, wherein the location of the guest device is determined by identifying the type of transport media to which the guest device is connected.

3. The method of claim 1, wherein intercepting the access request from the guest device further comprises:
determining whether the guest device is an authenticated subscriber by searching an active billing table for an identifier associated with said guest device; and
if a match is found, associating the service protocol with the MAC address of the guest device and granting the device immediate access to the Internet.

4. The method of claim 3, wherein the guest device accesses the Internet in accordance with the associated service protocol.

5. The method of claim 3, wherein determining whether the guest device is an authenticated subscriber further comprises:
if a match for the guest device is not found in the subscriber table,
spoofing the intercepted access request by replying to said access request with an IP address of the established network's portal server, thus establishing a connection between said guest device and the established network; and
redirecting the guest device to a predefined portal page associated with the guest device's location.

6. The method of claim 1, wherein the guest device is a portable device not originally configured to communication with the established network.

7. The method of claim 1, wherein the guest device is a computer not originally configured to communicate with the established network

8. The method of claim 1, wherein the guest device is a television.

9. The method of claim 3, wherein the access request in a DNS request.

10. The method of claim 3, wherein an ARP request transmitted by the guest device is spoofed by replying to said ARP request with the MAC address of the gateway.

11. The method of claim 1, wherein each the predefined portal page is associated with one of a plurality of locations within the established network.

12. The method of claim 11, wherein the predefined portal provides Internet service options available for each location within the established network.

13. The method of claim 9, wherein the portal page further provides for log in services.

14. The method of claim 9, wherein the portal page provides accounting and billing service options.

15. The method of claim 9, wherein the portal page provides a plurality of connection speeds options for the guest device.

16. The method of claim 8, wherein the portal page is a web-based login page offering predefined Internet service options based on the location of the guest device in the established network.

17. The method of claim 13, wherein the guest device becomes a subscriber by selecting service options on the portal page.

18. The method of claim 13, wherein the service protocol is developed from the selected service options and associated with the guest device.

19. The method of claim 13, wherein the locations throughout the established network utilize a variety of transport medium protocols.

20. The method of claim 17, wherein the location is configured with wireless transport medium protocol.

21. The method of claim 17, wherein the location is configured to utilize with an IEEE 802.1q VLAN transport medium protocol.

22. The method of claim 17, wherein the location is configured with a Docsis transport medium protocol.

23. The method of claim 17, wherein the location is configured to utilize any wired connection transport medium protocol.

24. The method of claim 17, wherein the location is configured with a SNMP 1493 transport medium protocol.

25. A method for redirecting network traffic to a portal based on the location of the transmitting device comprising:
spoofing an ARP request from a transmitting device with the MAC address of a gateway on an established network;
intercepting a packet having a destination address from a transmitting device and replying to said packet with an IP address of a predefined network server; and
determining the location of the transmitting device within the established network; and
redirecting the transmitting device to one of a plurality of portals page based on the determined location.

26. The method of claim 23, wherein the packet is a DNS request.

27. A system for providing diverse broadband service levels to multiple access points within an established network, the system comprising:
a guest device, connected to one of said multiple access points within the established network and configured to initiate a request for broadband service access;
a gateway in communication with said guest device, said gateway configured to intercept the request from the guest terminal and to identify the one of said multiple access points to which the guest device is connected;
a portal server for presenting said guest device with a portal page associated with the identified access point, wherein said guest device is provided service options available with said identified access point.

28. The system of claim 25, wherein the one of said multiple access points is configured to use a VLAN protocol.

29. The system of claim 25, wherein the one of said multiple access points is configured to use any wireless protocol.

30. The system of claim 25, wherein the one of said multiple access points is configured to use IEEE 801.q protocol.

31. The system of claim 25, wherein the one of said multiple access points is configured to use Docsis protocol.

32. The system of claim 25, wherein the one of said multiple access points provided a SMTP 1493 connection.

33. The system of claim 25, wherein the guest terminal is a wireless device.

34. The system of claim 25, wherein the guest terminal is a portable device.

35. The system of claim 25, wherein the guest terminal is a computer.

36. The system of claim 25, wherein the gateway identifies the one of said multiple access points to which the guest terminal is located based on the guest terminals MAC address.

37. The system of claim 25, wherein each one of said multiple access points is associated with a portal page.

38. The system of claim 25, wherein the user of said guest device selects the broadband service options from said portal.

39. The system of claim 36, wherein the selected broadband services options constitute the service protocol for said guest device.

40. The system of claim 37, wherein the selected broadband service options are stored in an authentication table and associated with the device's MAC address stored in an active billing table.
